(19) United States
(12) Patent Application Publication
(10) Pub. No.: US 2023/0021128 A1
(43) Pub. Date: Jan. 19, 2023

(54) ASSEMBLY OF METAL PIPES WITH TWO-COMPONENT POLYURETHANE ADHESIVE

(71) Applicant: BASF SE, Ludwigshafen am Rhein (DE)

(72) Inventors: YingHao Liu, Shanghai (CN); Stefan Bokern, Lemfoerde (DE); Xuyuan Peng-Poehler, Ludwigshafen am Rhein (DE); Li Ping Wang, Shanghai (CN); Yuan Yan Gu, Shanghai (CN); Dong Liang, Shanghai (CN); Yuan Fang, Shanghai (CN)

(21) Appl. No.: 17/782,898

(22) PCT Filed: Dec. 9, 2020
(86) PCT No.: PCT/EP2020/085281

§ 371 Date: Jun. 6, 2022

(30) Foreign Application Priority Data
Dec. 10, 2019 (CN) PCT/CN2019/124293

(51) Int. Cl. C09J 175/08; B32B 7/12; B32B 1/08; B32B 15/01; F16B 11/00; F16L 13/10

(52) U.S. Cl. CPC C09J 175/08; B32B 7/12; B32B 1/08; B32B 15/012; F16B 11/008; F16L 13/103; B32B 2037/1269

(57) ABSTRACT

Described herein is a method for joining a first metal pipe with a second metal pipe, the pipes being joined together in an overlapping area by use of a two-component polyurethane adhesive that encapsulates the overlapping area, where the method includes the steps of:

(1) applying the two-component polyurethane adhesive onto an inner surface of a fixture;
(2) inserting one end of the first metal pipe into one end of the second metal pipe so as to form a pipe assembly having the overlapping area between the two ends, and putting the overlapping area of the pipe assembly into the fixture; (3) closing the fixture such that the overlapping area of the pipe assembly is fixed in the fixture, and such that the adhesive therein encapsulates the overlapping area of the pipe assembly; (4) curing the two-component polyurethane adhesive; and (5) optionally, removing the fixture from the pipe assembly.

### TECHNICAL FIELD

The present invention relates to a method for assembling metal pipes, especially metal pipes used in coolant systems, with two-component polyurethane adhesives.

### BACKGROUND

During the production of coolant systems, such as fridges or air conditioner, metal coolant pipes for the cooling medium must be joined together. A standard process for joining metal coolant pipes is welding by virtue of welding powder, such as copper brazing. However, welding these pipes has the drawback that owing to dissimilar materials of the pipes, they cannot be joined easily, welding can damage the pipes thermally, and the welding spot has to be protected against corrosion in a second step. Additionally, thermo-mechanical and mechanical stress is transmitted through the welding points. In this regard, some methods have been developed for adhesively bonding metal coolant pipes. For example, EP 2274 549 B1 discloses a method for joining a first tube and a second tube, the pipes being joined together in an overlap zone using an adhesive which fills a gap in the overlap zone between the pipes. In this document, the adhesive is selected from 1C thermal-cure Epoxy and thus it needs to be thermally activated by heating the overlap zone with the assistance of the heatable clamp. Specifically, EP 2274 549 B1 discloses that 1C thermal-cure Epoxy system requires heating for a certain period of time at above 50° C., which decrease the productivity. Additionally, thermal-cure epoxy systems tend to be relatively brittle.

Therefore, it is still required to provide new methods, by which metal coolant pipes can be joined at room temperature, and which increases the productivity and requires less energy consumption and simplifies the production process.

### SUMMARY OF THE PRESENT INVENTION

An object of this invention is to overcome the problems of the prior art discussed above and to provide a method for assembling metal pipes, especially metal pipes used in coolant systems, with two-component polyurethane adhesives at room temperature, and at the same time the method achieves high strength connection and good sealing at the junction of the metal pipes.

Surprisingly, it has been found by the inventors that the above object can be achieved by a method for joining a first metal pipe with a second metal pipe, the pipes being joined together in an overlapping area by use of a two-component polyurethane adhesive that encapsulates the overlapping area,

wherein the method comprises the steps of:

(1) applying the two-component polyurethane adhesive onto the inner surface of a fixture;

(2) inserting one end of the first metal pipe into one end of the second metal pipe so as to form a pipe assembly having the overlapping area between the two ends, and putting the overlapping area of the pipe assembly on the fixture;

(3) closing the fixture such that the overlapping area of the pipe assembly is fixed in the fixture, and that the adhesive therein encapsulates the overlapping area of the pipe assembly;

(4) curing the adhesive; and

(5) optionally, removing the fixture from the pipe assembly.

In a preferred embodiment, the fixture has an axisymmetric shape, such as circular pipe shape, ellipsoidal shape and fusiform.

In a preferred embodiment, the fixture is arranged concentrically with the pipe assembly in step (2).

In a preferred embodiment, the fixture forms a closed capsule during the closing step.

In a preferred embodiment, the two-component polyurethane adhesive has a temperature Tg between 10° C. and 60° C., preferably between 20° C. and 45° C.

In a preferred embodiment, the two-component polyurethane adhesive has a lap shear strength of above 13 M Pa according to test method: ISO4587.

In a preferred embodiment, the two-component polyurethane adhesive comprising

component A, each based on the total amount of component A, consisting of
(1) a polyol composition, comprising
   (a) 8-15 wt % of branched polyether polyol;
   (b) 15-20 wt % of bisphenol A based polyether polyol; and
   (c) 10-25 wt % of castor oil based polyether polyol;
(2) 0.2-2 wt % of chain extender and/or crosslinking agent,
(3) 40-65 wt % of filler,
(4) 0-1 wt % of catalysts, and
(5) 0-12 wt % of additives and/or auxiliaries,

wherein the sum of the above components totals 100 wt %; and
component B consisting of at least one isocyanate;

In a more preferred embodiment, the two-component polyurethane adhesive comprises component A, each based on the total amount of component A, consisting of
(1) polyol composition, comprising
   (a) 8-15wt % of polyether polyol A selected from branched polyether polyol, with Mw 1000-4000 and OH Value 50-350;
   (b) 15-20 wt % of polyether polyol B selected from bisphenol A based polyether polyol, with 40C viscosity 5000-10000 mPas and OH value 265-295; and
   (c) 10-25 wt % of polyether polyol C selected from castor oil based polyether polyol, with R.T. viscosity 650-800 mPas and OH Value 40-60;
(2) 0.2-2 wt % of chain extender and/or crosslinking agent,
(3) 40-65 wt % of filler selected from inorganic filler, and optionally
(4) 0-1wt % of catalysts, and
(5) 0-12wt % of additives and/or auxiliaries,

wherein the sum of the above components totals 100 wt %; and

component B consisting of at least one isocyanate;

wherein the amount of component B is selected such that the isocyanate index is 100-110, preferably 102-105.

In a preferred embodiment, the material of the first metal pipe and the second metal pipe are selected from steel, copper or aluminum, preferably copper or aluminum; and the material of the first metal pipe may be the same or different from that of the second tube.

In a preferred embodiment, the inorganic filler is selected from calcium carbonate, barium sulfate, talc or argil, preferably calcium carbonate.

In a preferred embodiment, the pipes are used for coolant applications in fridges and air conditioner applications.

It has been surprisingly found in this application that, by using two-component polyurethane adhesives by virtue of the fixture at room temperature, the inventive method increases the productivity, requires less energy consumption, and simplifies the production process. The two-component polyurethane adhesive shows high adhesion strength between metal plates and high toughness, and additionally high temperature stability, hydrolysis and coolant resistance, and thus contributes to high strength connection and good sealing at the junction of the pipe assembly.

### DESCRIPTION OF FIGURES

FIG. 1 shows high adhesion strength between metal plates of the two-component polyurethane adhesive.

FIG. 2 shows the sample preparation process for Cataplasm test.

FIG. 3 shows high hydrolysis resistance of the two-component polyurethane adhesive.

FIG. 4 shows high media resistance of the two-component polyurethane adhesive.

FIG. 5 shows high temperature resistance of the two-component polyurethane adhesive.

FIG. 6 shows the good adhesion of the two-component polyurethane adhesive to welding powder.

FIG. 7 shows the high temperature aging appearance of the pipes.

FIG. 8 shows the low temperature aging appearance of the pipes.

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article or component.

Unless otherwise identified, all percentages (%) are “percent by weight”.

Unless otherwise identified, the temperature refers to room temperature and the pressure refers to ambient pressure.

The present invention provides a method for joining a first metal pipe with a second metal pipe, the pipes being joined together in an overlapping area by use of a two-component polyurethane adhesive that encapsulates the overlapping area, wherein the method comprises the steps of:

(1) applying the two-component polyurethane adhesive onto the inner surface of a fixture;

(2) inserting one end of the first metal pipe into one end of the second metal pipe so as to form a pipe assembly having the overlapping area between the two ends, and putting the overlapping area of the pipe assembly on the fixture;

(3) closing the fixture such that the overlapping area of the pipe assembly is fixed in the fixture, and that the adhesive therein encapsulates the overlapping area of the pipe assembly;

(4) curing the adhesive; and

(5) optionally, removing the fixture from the pipe assembly.

In the present application, a first metal pipe and a second metal pipe, are usually connected along the concentric axis direction so as to form a pipe assembly, and the overlapping area of the pipe assembly refers to mechanical joint or welded joint thereof, for example, a case that one end of the first metal pipe is inserts into a flared end of the second metal pipe and thus form an overlapping area. The metal pipes are selected from steel, copper or aluminum, preferably copper or aluminum. The materials of the first metal pipe and the second metal pipe can be identical or different. For example, the first metal pipe is made copper and the second metal pipe is made aluminum, and vice versa. Also, it is possible that both the first metal pipe and the second metal pipe are made from copper or aluminum. Herein, preferably, the material of the first metal pipe is different from that of the second metal pipe.

In the present application, the two-component polyurethane adhesive comprises component A, each based on the total amount of component A, consisting of
(1) a polyol composition, comprising
   (a) 8-15 wt % of branched polyether polyol;
   (b) 15-20 wt % of bisphenol A based polyether polyol; and
   (c) 10-25 wt % of castor oil based polyether polyol;
(2) 0.2-2 wt % of chain extender and/or crosslinking agent,
(3) 40-65 wt % of filler,
(4) 0-1 wt % of catalysts, and
(5) 0-12 wt % of additives and/or auxiliaries,

wherein the sum of the above components totals 100 wt %; and
component B consisting of at least one isocyanate, wherein the amount of
component B is selected such that the isocyanate index is 100-110.

Steps (1)-(5)

In step (1), the amount of the two-component polyurethane adhesive is determined firstly according to the actual consumption, and then the components A and B of the two-component polyurethane adhesive are premixed to obtain a homogeneous mixture by using static mixer. Then, within operation time of the two-component polyurethane, it is applied onto a special designed fixture. After application of the adhesive to the fixture and prior to the connection of pipes, the adhesive is not cured within operation time, such as 1 to 15 minute (min), preferably 2 to 10, more preferably 2 to 8 min.

In the context of the present application, the fixture means a foldable instrument, which can form a closed capsule when used. In use, the fixture makes the adhesive in the fixture fill the gap of the overlapping area of the pipe assembly and encapsulate the outer surface area of the pipe assembly at the overlapping area. The fixture could be made from any suitable materials, such as plastic or metal. The shape of the fixture is adaptive to the shape of the overlapping area of the pipe assembly, so as to better fix the area.

The fixture preferably has an axisymmetric shape, such as circular pipe shape, ellipsoidal shape and fusiform.

In step (2), the fixture having adhesive is placed concentrically to the pipe assembly such that the overlapping area of the pipe assembly can be evenly stressed during clamping step.

In step (3), the fixture is closed to form a closed capsule, so as to make the adhesive in the fixture fill the gap of the overlapping area between the two pipes and encapsulates the outer surface area of the metal pipes at the overlapping area, i.e., at the junction of the pipe assembly. The adhesive provides good wetting to the pipe's surface to enhance the sealing performance.

Depending on the components of the two-component polyurethane adhesive, it is gradually cured within a few minutes, such as 30 to 80 min, preferably 50-65 min, to obtain an initial adhesive strength, and is fully cured after at least 1 day to obtain the final adhesive strength.

In step (4), the adhesive is gradually cured after fixation by the fixture to achieve an initial bonding strength within hours, to form the connection and sealing for initial transportation. The adhesive shows final high bonding strength within several hours, such as more than 24 hours, to form high strength connection and good sealing for the pipes.

In step (5), after the adhesive is fully cured, the fixture can be either removed from the pipe assembly, or can be kept on the pipe assembly.

### Two-Component Polyurethane Adhesive

Component A

(1) Polyol Composition

Polyol composition used in the present application is a mixture of polyether polyol A, polyether polyol B and polyether polyol C. Polyether polyol A is selected from branched polyether polyol, with Mw 1000-4000 and OH Value 50-350. By way of example, branched polyether polyol can be selected from Sovermol 750, Sovermol 815, or Lupraphen 2600. The amount of polyether polyol A, based on the total weight of component A, is preferably from 8 to 15% by weight, particularly preferably from 8 to 12% by weight, and in particular from 10 to 12% by weight.

Polyether polyol B is selected from bisphenol A based polyether polyol, with 40° C. viscosity 5000-10000 mPa·s and OH value 265-295. The amount of Polyether polyol B, based on the total weight of component A, is preferably from 15 to 20% by weight, particularly preferably from 15 to 18% by weight.

Polyether polyol C is selected from castor oil based polyether polyol, with room temperature (R.T.) viscosity 650-800 mPas and OH Value 40-60. The amount of Polyether polyol C, based on the total weight of component A, is preferably from 10 to 25% by weight, particularly preferably from 10 to 20% by weight, and in particular from 10 to 15% by weight.

The above polyether polyols can be used in the invention are produced by known processes or can be commercially available.

(2) Chain Extender and/or Crosslinking Agent

Chain extenders and/or crosslinking agents (2) that can be used are substances having a molar mass which is preferably smaller than 500 g/mol, particularly preferably from 60 to 400 g/mol, wherein chain extenders have 2 hydrogen atoms reactive toward isocyanates and crosslinking agents have 3 hydrogen atoms reactive toward isocyanate. These can be used individually or preferably in the form of a mixture. It is preferable to use diols and/or triols having molecular weights smaller than 500, particularly from 60 to 400, and in particular from 60 to 350. Examples of those that can be used are aliphatic, cycloaliphatic, and/or araliphatic diols having from 2 to 14, preferably from 2 to 10, carbon atoms, e.g. ethylene glycol, 1,3-propanediol, 1,4-butanediol, 1,6-hexanediol, 1,10-decanediol, 1,2-, 1,3-, and 1,4-dihydroxycyclohexane, diethylene glycol, dipropylene glycol, tripropylene glycol, diethanolamine, or triols, e.g. 1,2,4- or 1,3,5-trihydroxycyclohexane, glycerol, and trimethylolpropane. Preference is given to using diethylene glycol, dipropylene glycol or tripropylene glycol, especially tripropylene glycol.

The amount of chain extender and/or crosslinking agent c) is preferably from 0.1 to 5% by weight, particularly preferably from 0.1 to 2% by weight, based on the total weight of component A.

(3) Filler

In the present application, filler that can be used is inorganic filler, which is selected from calcium carbonate, barium sulfate, talc or argil, preferably calcium carbonate. The inventor has found that the use of inorganic filler, especially calcium carbonate, can reduce cost and can be beneficial to improved properties of the obtained polyurethane adhesive in terms of the tensile shear strength and the mechanical property. The amount of inorganic filler is preferably from 40 to 65% by weight, particularly preferably from 40 to 55% by weight, based on the total weight of component A.

(4) Catalyst

As catalyst (4), it is possible to use all compounds which accelerate the isocyanate-polyol reaction. Such compounds are known and are described, for example, in “Kunststoffhandbuch, volume 7, Polyurethane”, Carl Hanser Verlag, 3rd edition 1993, chapter 3.4.1. These comprise amine-based catalysts and catalysts based on organic metal compounds.

As catalysts based on organic metal compounds, it is possible to use, for example, organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates, e.g. bismuth(III) neodecanoate, bismuth 2 ethylhexanoate and bismuth octanoate, or alkali metal salts of carboxylic acids, e.g. potassium acetate or potassium formate.

Preference is given to using amine-based catalysts as catalyst (4), such as N,N,N′,N′-tetramethyldipropylenetriamine, 2-[2-(dimethylamino)ethyl-methylamino]ethanol, bis(2-dimethylaminoethyl) ether, N,N,N,N,N-pentamethyldiethylenetriamine, N,N,N-triethylaminoethoxyethanol, dimethylcyclohexylamine, trimethyl hydroxyethyl ethylenediamine, dimethylbenzylamine, triethylamine, triethylenediamine, pentamethyldipropylenetriamine, dimethylethanolamine, N-methylimidazole, N ethylimidazole, tetramethylhexamethylenediamine, tris(dimethylaminopropyl)hexahydrotriazine, dimethylaminopropylamine, N-ethylmorpholine, diazabicycloundecene and diazabicyclononene. Preference is given to using triethylamine or triethylenediamine, especially triethylenediamine.

The amount of catalyst (4), if present, based on the total weight of component A, is preferably from 0 to 1% by weight, particularly preferably from 0.2 to 0.8% by weight.

(5) Additives and/or Auxiliaries

Additives and/or auxiliaries (5) that can be used comprise surfactants, cell opener, preservatives, colorants, antioxidants, reinforcing agents, stabilizers and water absorbent. In preparing polyurethane adhesive, it is generally to employ one of above additives and/or auxiliaries, or the mixture thereof, so as to improve the properties of the obtained polyurethane adhesive, such as the product stability during storage, i.e. shelf life. Here, water absorber, such as NingRui 100/3A can be used to improve shelf life of the polyurethane adhesive. Typically, the amount of additives and/or auxiliaries, is preferably from 0 to 12% by weight, more preferably from 0.1 to 10% by weight, based on the total weight of component A.

Further information concerning the mode of use and of action of the abovementioned auxiliaries and additives, and also further examples, are given by way of example in “Kunststoffhandbuch, Band 7, Polyurethane” [“Plastics handbook, volume 7, Polyurethanes”], Carl Hanser Verlag, 3rd edition 1993, chapter 3.4.

Component B

Component B consists of at least one isocyanate. Isocyanates used for producing the polyurethane adhesive of the invention comprise all isocyanates known for producing polyurethanes. These comprise aliphatic, cycloaliphatic, araliphatic and/or aromatic isocyanates, such as tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), polymeric MDI, naphthylene 1,5-diisocyanate (NDI), tolylene 2,4- and/or 2,6-diisocyanate (TDI), 3,3′-dimethyl diphenyl diisocyanate, 1,2-diphenylethane diisocyanate and/or phenylene diisocyanate. Particular preference is given to using diphenylmethane 2,2′-, 2,4′- and/or 4,4′-diisocyanate, and polymeric MDI, especially diphenylmethane 4,4′-diisocyanate.

The amount of component B is selected such that the isocyanate index is 100-110, preferably 102-105, especially 103.

### EXAMPLES

The present invention will now be described with reference to Examples and Comparative Examples, which are not intended to limit the present invention.

The following starting materials were used:
Isocyanate:
   Diphenylmethane 4,4′-diisocyanate
Polyether polyol:
   Polyether polyol A selected from branched polyether polyol, commercially available from BASF under Sovermol®815;
   Polyether polyol B selected from bisphenol A based polyether polyol, with 40° C. viscosity 7500 mPa·s and OH value 280; and
   Polyether polyol C selected from castor oil based polyether polyol, with R.T. viscosity 725 mPa·s and OH Value 50;
Filler: calcium carbonate
Catalyst: triethylenediamine,
Chain extender: tripropylene glycol
additives and/or auxiliaries: NingRui 100/3A

The following methods were used to determine properties:

| | |
|---|---|
| Lap shear strength in MPa: | ISO 4587 |
| Tensile strength in MPa: | ISO 527 |
| Strain at rupture/%: | ISO 527 |
| E-modulus N/mm²: | ISO 527 |
| Viscosity in mPas: | GB/T22235-2008 |
| OH Value: | DIN 53240 |
| Density in kg/m³: | GB/T 6343-2008 |

### Example 1

### Preparation the Two-Component Polyurethane Adhesive

A two-component polyurethane adhesive was synthesized from the components as shown in table 1, and the amounts of each components are shown in table 1 as well. Firstly, the composition of component A was mixed together to form a milky liquid, and then the obtained liquid was mixed with component B in a static mixer to obtain the adhesive. The properties of the component A, component B and the adhesive are shown in tables 2 and 3 as follows.

TABLE 1

| | Amount (wt %) |
|---|---|
| Component A | |
| polyether polyol A | 10.55 |
| polyether polyol B | 17 |
| polyether polyol C | 13 |
| calcium carbonate | 50 |
| tripropylene glycol | 1 |
| triethylenediamine | 0.2 |
| NingRui 100/3A | 8.25 |
| Component B | |
| Diphenylmethane 4, 4′-diisocyanate | to NCO index 103 |

TABLE 2

| | Component A | Component B |
|---|---|---|
| appearance | milky liquid | Brown liquid |
| viscosity(20° C.), mPa · s | 30,000 ± 5000 | 250 ± 100 |
| density(25° C.), g/cm³ | 1.50 ± 0.05 | 1.22 ± 0.05 |
| volume ratio | 4 | 1 |

TABLE 3

| | Two-component PU Adhesive |
|---|---|
| appearance | liquid |
| viscosity(20° C.), mPa · s | 9600 ± 1000 |

### Example 2

Joining and sealing of two metal pipes using the adhesive of example 1.

The two metal pipes were first cleaned with ethanol and dried in air for 10 min to allow complete solvent evaporation. The first pipe is made of copper and the second pipe is made of aluminum. One end of the first pipe was inserted into one end of the second pipe so as to form a pipe assembly having the overlapping area between the two ends.

Once the adhesive of example 1 was obtained in the static mixer, it was discharged from the mixer and then applied on one side of a fixture, within 5 min of operation time thereof. The foldable fixture is made from polypropylene and has an axisymmetric fusiform shape. The fixture having the adhesive applied on one side thereof was placed concentrically to the pipe assembly. The fixture was then closed, such that the adhesive in the fixture filled the gap of the overlapping area of the pipe assembly and encapsulated the outer surface area of the pipe assembly at the overlapping area. The adhesive was gradually cured within 60 min to achieve an initial bonding strength. The adhesive showed final high bonding strength within 2 days.

After the adhesive was fully cured, the following test was carried out to evaluate the joining and sealing effect, wherein the welding metal pipes are assembled by the first pipe made of copper and the second pipe made of aluminum.

1. High Temperature Aging

The test proceeded as follows:

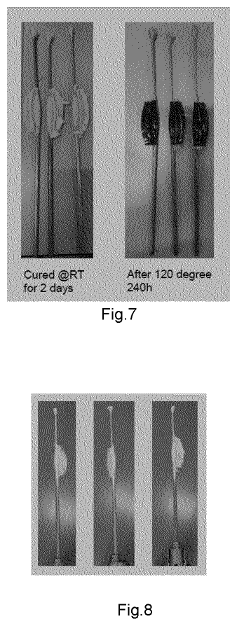

The cured sample according to example 1 was placed in a 120° C. oven for 240 hours with one end of the aluminum pipe sealed by the same adhesive. This assembled sample was placed under water and then injected with 1.8 MPa of compressed nitrogen gas for 5 min to visually check if there is any observable leakage. The testing was conducted with 3 duplicates, as shown in FIG. 7.

The results show that all samples are sealed well and of no leakage, showing excellent sealing of the 2-component PU adhesive for the pipe assembly.

2. Low Temperature Aging

The test proceeded as follows:

The cured sample according to example 1 was placed in a −30° C. refrigerator for 240 hours with one end sealed by the same adhesive. This assembled sample was placed under water and then injected with 1.8 MPa of compressed nitrogen gas for 5 min to visually check if there is any observable leakage. The testing was conducted with 3 duplicates, as shown in FIG. 8.

The results show that all samples are sealed well and of no leakage, showing excellent sealing of the 2-component PU adhesive for the pipe assembly.

3. Room Temperature Aging

The test proceeded as follows:

The cured sample according to example 1 was kept at room temperature for 240 hours with one end sealed by the same adhesive. This assembled sample was placed under water and then injected with 1.8 MPa of compressed nitrogen gas for 5 min to visually check if there is any observable leakage. The testing was conducted with 3 duplicates.

The results show that all samples are sealed well and of no leakage, showing excellent sealing of the 2-component PU adhesive for the pipe assembly.

From the above test results, it can be seen that the inventive method provides excellent joining and sealing effect for metal pipes. Thus, the inventive method can be used to replace the welding process or as a complement to welding in order to avoid solder skips.

### Example 3

### Performance Evaluation of the Two-Component Polyurethane Adhesive

1. The two-component polyurethane adhesive shows high adhesion strength between metal plates.

The two standard Al plates were sandblasted and cleaned with ethanol, and dried in air for 10 min to allow complete solvent evaporation. Then a 2-component PU adhesive was applied on the surface of the lap joint between two Al plates. The adhesives were then pressed to 2 mm thickness using glass micro-bubbles as caliber to control thickness followed by 3 days of curing. The lap shear strength experiment was conducted according to Test method: ISO 4587. The testing was conducted with 3 duplicates.

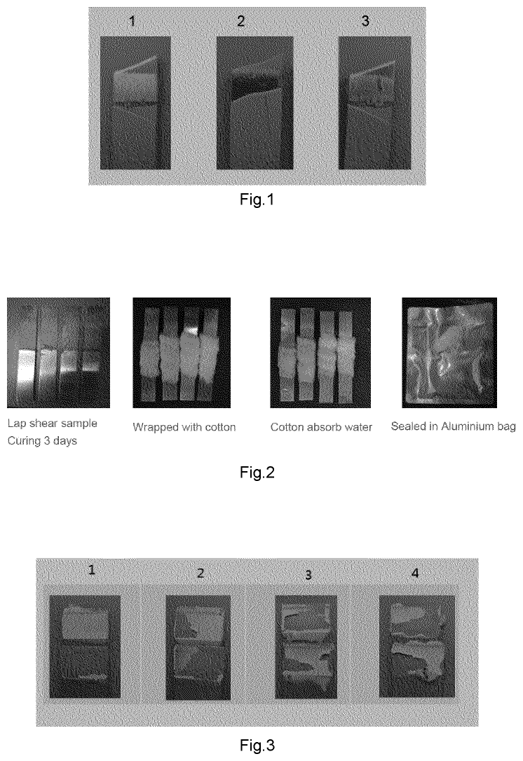

As shown in table 4 and FIG. 1, an average lap shear strength of 14.6 MPa with substrate failure was achieved.

TABLE 4

| | experiment number | | | |
|---|---|---|---|---|
| | 1 | 2 | 3 | Average |
| lap shear strength/MPa | 13.6 | 14.6 | 15.6 | 14.6 |
| Fracture pattern | substrate | substrate | substrate | |
| | failure | failure | failure | |

2. The two-component polyurethane adhesive shows high hydrolysis resistance.

Hydrolysis resistance was tested by Cataplasm test (as shown in FIG. 2).

The two standard Al plates were sandblasted and cleaned with ethanol, and dried in air for 10 min to allow complete solvent evaporation. Then a 2-component PU adhesive was applied on the surface of the lap joint between two Al plates. The adhesives were then pressed to 2 mm thickness using glass micro-bubbles as caliber to control thickness followed by 3 days of curing. The cured samples were wrapped with wet cotton and kept in a heat-sealed Al-foil bag. The samples were placed in an 80° C. oven for 10 days before lap shear strength test. The lap shear strength and failure mode were recorded in the table below. The testing was conducted with 3 duplicates.

As shown in table 5 below and FIG. 3, an average lap shear strength of 14.9 MPa (Test method: ISO 4587) was achieved with adhesion failure.

TABLE 5

| | experiment number | | | | |
|---|---|---|---|---|---|
| | 1 | 2 | 3 | 4 | Average |
| lap shear | 13.4 | 13.8 | 14.9 | 17.6 | 14.9 |
| strength/MPa | | | | | |
| Fracture pattern | Substrate | Adhesion | Adhesion | Adhesion | |
| | cohesion | | | | |

3. The two-component polyurethane adhesive shows high media resistance.

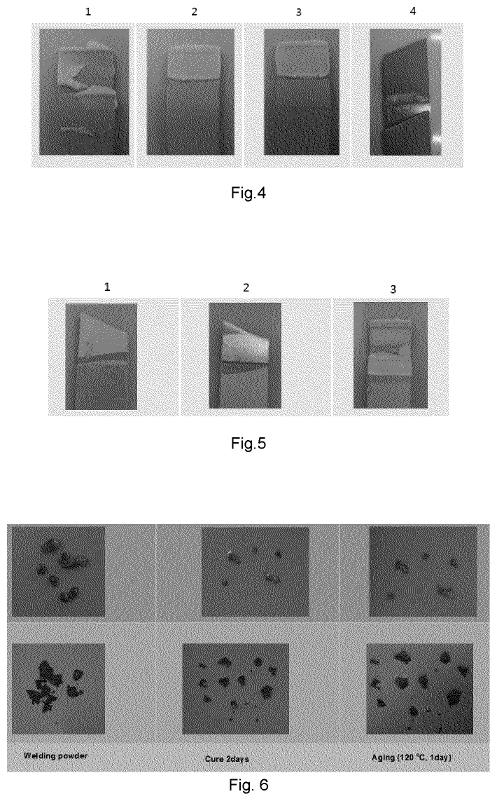

The two standard Al plates were sandblasted and cleaned with ethanol, and dried in air for 10 min to allow complete solvent evaporation. Then a 2-component PU adhesive was applied on the surface of the lap joint between two Al plates. The samples were pressed to 2 mm thickness using glass micro-bubbles as caliber to control adhesive thickness followed by 3 days of curing. The cured samples were then immersed in motor oil at room temperature for 72 hours before lap shear test. The lap shear strength and failure mode were recorded in table 6 below and as shown in FIG. 4. The testing was conducted with 3 duplicates.

An average lap shear strength of 13.9 MPa (Test method: ISO 4587) with substrate failure was achieved.

TABLE 6

| | experiment number | | | | |
|---|---|---|---|---|---|
| | 1 | 2 | 3 | 4 | Average |
| lap shear | 14.0 | 13.8 | 13.6 | 14.2 | 13.9 |
| strength/MPa | | | | | |
| Fracture pattern | Near | Near | Near | substrate | |
| | substrate | substrate | substrate | failure | |
| | cohesion | cohesion | cohesion | | |

4. The two-component polyurethane adhesive shows high temperature resistance. The two standard Al plates were sandblasted and cleaned with ethanol, and dried in air for 10 min to allow complete solvent evaporation. Then a 2-component PU adhesive was applied on the surface of the lap joint between two Al plates. The adhesives were then pressed to 2 mm thickness using glass micro-bubbles as caliber to control thickness followed by 3 days of curing. The cured samples were kept at 120° C. for 2 days and then the lap shear strength was measured. The testing was conducted with 3 duplicates.

An average lap shear strength of 15.9 MPa (Test method: ISO 4587) with mostly substrate failure was achieved, as shown in table 7 below and FIG. 5.

TABLE 7

| | experiment number | | | |
|---|---|---|---|---|
| | 1 | 2 | 3 | Average |
| lap shear strength/MPa | 17.1 | 16.4 | 14.2 | 15.9 |
| Fracture pattern | substrate | substrate | substrate | |
| | failure | failure | failure | |

5. The two-component polyurethane adhesive shows high Tensile strength Determination of tensile properties of the two-component polyurethane adhesive proceeded according to the method: ISO 527

Test condition: 80° C., 7 days, immersed in water, thickness 4 mm, test speed: 20 mm/min.

Test condition: 80° C., 10 days, immersed in water, thickness 4 mm, test speed: 20 mm/min.

The results are shown in table 8 below.

TABLE 8

| | Tensile | Strain at | E-modulus |
|---|---|---|---|
| | strength/MPa | rupture/% | N/mm² |
| standard | 39.2 | 3.4 | 2513.3 |
| 80° C., 7 days | 17.6 | 89.8 | 388.0 |
| (water) | | | |
| 80° C., 10 days | 39.6 | 12.1 | 2310.0 |
| (oven) | | | |

6. The two-component polyurethane adhesive shows the good adhesion to welding powder

In this test, the used welding powders are copper welding powder, and silver-steel alloy welding powder.

The test proceeded as follows:

Two-component polyurethane adhesive prepared in Example 1 was poured into a 2 mm-thick mold, and then the welding powders were placed on the surface of the adhesive, followed by curing at room temperature for 2 days. The cured sample was then placed in a 120° C. oven for 24 h, after which the samples were checked to see if the welding powders have detached from PU adhesives.

The results, as shown in FIG. 6, show that after aging at 120° C. for 24 h, the adhesive still shows good adhesion to welding powder.

From the above results, it can be seen that the two-component polyurethane adhesives has good low temperature and high temperature resistance, high media resistance and hydrolysis resistance, excellent adhesion strength, lap shear strength even above 15 MPa, and are suitable for joining and sealing of metal pipes with or without welding.

In the present application, by using the two-component polyurethane adhesives and adopting the specific fixture, the inventive method can proceed at room temperature, and thus increases the productivity, requires less energy consumption, and simplifies the production process, while providing high strength connection and good sealing at the junction of the metal pipes.

The structures, materials, compositions, and methods described herein are intended to be representative examples of the invention, and it will be understood that the scope of the invention is not limited by the examples. Those skilled in the art will recognize that the invention may be practiced with variations on the disclosed structures, materials, compositions, and methods, and such variations are regarded as within the ambit of the invention. Thus, it is intended that the present invention cover such modifications and variations as come within the scope of the appended claims and their equivalents.

1. A method for joining a first metal pipe with a second metal pipe, the pipes being joined together in an overlapping area by use of a two-component polyurethane adhesive that encapsulates the overlapping area, wherein the method comprises the steps of:
(1) applying the two-component polyurethane adhesive onto an inner surface of a fixture;
(2) inserting one end of the first metal pipe into one end of the second metal pipe so as to form a pipe assembly having the overlapping area between the two ends, and putting the overlapping area of the pipe assembly on the fixture;
(3) closing the fixture such that the overlapping area of the pipe assembly is fixed in the fixture, and such that the adhesive therein encapsulates the overlapping area of the pipe assembly;
(4) curing the two-component polyurethane adhesive; and
(5) optionally, removing the fixture from the pipe assembly.

2. The method according to claim 1, wherein the closed fixture in step (3) has an axisymmetric shape.

3. The method according to claim 2, wherein the fixture forms a closed capsule during the closing step (3).

4. The method according to claim 2, wherein the fixture is arranged concentrically with the pipe assembly in step (2).

5. The method according to claim 1, wherein the two-component polyurethane adhesive has a temperature Tg between 10° C. and 60° C.

6. The method according to claim 1, wherein the two-component polyurethane adhesive has a lap shear strength of above 13 MPa according to test method: ISO4587.

7. The method according to claim 1, wherein the two-component polyurethane adhesive comprises
component A, comprising, each based on a total weight of component A,
(1) a polyol composition, comprising
(a) 8-15 wt % of branched polyether polyol;
(b) 15-20 wt % of bisphenol A based polyether polyol; and
(c) 10-25 wt % of castor oil based polyether polyol;
(2) 0.2-2 wt % of chain extender and/or crosslinking agent,
(3) 40-65 wt % of filler,
(4) 0-1 wt % of catalysts, and
(5) 0-12 wt % of additives and/or auxiliaries,
wherein a sum of the above components totals 100 wt %; and
component B comprising at least one isocyanate.

8. The method according to claim 1, wherein the two-component polyurethane adhesive comprises
component A, comprising, each based on a total weight of component A,
(1) polyol composition, comprising
(a) 8-15wt % of Polyether polyol A selected from the group consisting of branched polyether polyol, with Mw 1000-4000 and OH Value 50-350;
(b) 15-20 wt % of Polyether polyol B selected from the group consisting of bisphenol A based polyether polyol, with 40° C. viscosity 5000-10000 mPa·s and OH value 265-295; and
(c) 10-25 wt % of Polyether polyol C selected from the group consisting of castor oil based polyether polyol, with R.T. viscosity 650-800 mPa·s and OH Value 40-60;
(2) 0.2-2 wt % of chain extender and/or crosslinking agent,
(3) 40-65 wt % of filler selected from the group consisting of inorganic filler, and optionally
(4) 0-1 wt % of catalysts, and
(5) 0-12 wt % of additives and/or auxiliaries,
wherein a sum of the above components totals 100 wt %; and
component B comprising at least one isocyanate;
wherein an amount of component B is selected such that the isocyanate index is 100-110.

9. The method according to claim 8, wherein the inorganic filler is selected from the group consisting of calcium carbonate, barium sulfate, talc and argil.

10. The method according to claim 1, wherein a material of the first metal pipe and a material of the second metal pipe are selected from the group consisting of steel, copper and aluminum; and the material of the first metal pipe may be the same or different from the material of the second metal pipe.

11. The method according to claim 1, wherein the pipes are used for coolant applications in fridges or air conditioner applications.

12. The method according to claim 1, wherein the closed fixture in step (3) has a circular pipe shape, an ellipsoidal shape or is fusiform.

13. The method according to claim 1, wherein the two-component polyurethane adhesive has a temperature Tg between 20° C. and 45° C.

14. The method according to claim 1, wherein the two-component polyurethane adhesive comprises
component A, comprising, each based on a total of component A,
(1) polyol composition, comprising
(a) 8-15wt % of Polyether polyol A selected from the group consisting of branched polyether polyol, with Mw 1000-4000 and OH Value 50-350;
(b) 15-20 wt % of Polyether polyol B selected from the group consisting of bisphenol A based polyether polyol, with 40° C. viscosity 5000-10000 mPa·s and OH value 265-295; and
(c) 10-25 wt % of Polyether polyol C selected from the group consisting of castor oil based polyether polyol, with R. T. viscosity 650-800 mPa·s and OH Value 40-60;
(2) 0.2-2 wt % of chain extender and/or crosslinking agent,
(3) 40-65 wt % of filler selected from the group consisting of inorganic filler, and optionally
(4) 0-1 wt % of catalysts, and
(5) 0-12 wt % of additives and/or auxiliaries,
wherein a sum of the above components totals 100 wt %; and
component B comprising at least one isocyanate;
wherein an amount of component B is selected such that the isocyanate index is 102-105.

15. The method according to claim 14, wherein the inorganic filler is selected from the group consisting of calcium carbonate.

16. The method according to claim 8, wherein the inorganic filler is selected from the group consisting of calcium carbonate.

17. The method according to claim 1, wherein a material of the first metal pipe and a material of the second metal pipe are selected from the group consisting of copper and aluminum; and the material of the first metal pipe may be the same or different from the material of the second metal pipe.
